(19) United States
(12) Patent Application Publication
(10) Pub. No.: US 2026/0244902 A1
(43) Pub. Date: Aug. 20, 2026

(54) SYSTEMS AND METHODS FOR OBTAINING NEURAL NETWORKS FOR DATA COMPRESSION

(71) Applicant: GUANGDONG OPPO MOBILE TELECOMMUNICATIONS CORP., LTD., Dongguan (CN)

(72) Inventors: Slawomir ROZEK, Poznan (PL); Marek DOMANSKI, Poznan (PL); Tomasz GRAJEK, Poznan (PL); Slawomir MACKOWIAK, Poznan (PL); Olgierd STANKIEWICZ, Poznan (PL); Jakub STANKOWSKI, Poznan (PL); Maciej WAWRZYNIAK, Poznan (PL)

(73) Assignee: GUANGDONG OPPO MOBILE TELECOMMUNICATIONS CORP., LTD., Dongguan (CN)

(21) Appl. No.: 19/642,933

(22) Filed: Apr. 9, 2026

Related U.S. Application Data
(63) Continuation of application No. PCT/CN2024/122294, filed on Sep. 29, 2024.

(30) Foreign Application Priority Data
Oct. 9, 2023 (EP) 23461661.3

(51) Int. Cl. G06N 3/0455; G06N 3/08; H04N 19/42; G10L 19/00; H04N 19/117; H04N 19/86

(52) U.S. Cl. CPC G06N 3/0455; G06N 3/08; H04N 19/42; G10L 19/00; H04N 19/117; H04N 19/86

(57) ABSTRACT

There is provided a method for obtaining a neural network for use in data compression. The method includes initializing an encoder-side neural network at an encoding system; initializing a decoder-side neural network at a decoding system; herein the encoder-side and decoder-side neural networks have the same architecture and starting parameters; obtaining, by the encoding system, a training data item; encoding, by the encoding system, the training data item to generate a compressed training data item; transmitting, by the encoding system, the compressed training data item; receiving, by the decoding system, the compressed training data item; and training the encoder-side and decoder-side neural networks based upon the compressed training data item such that the encoder-side and decoder-side neural networks remain identical.

### CROSS-REFERENCE TO RELATED APPLICATION

This is a continuation application of International Patent Application No. PCT/CN2024/122294, filed on September 29, 2024, which claims a priority to Europe Application No. 23461661.3, filed on October 09, 2023, the disclosures of which are hereby incorporated by reference in their entireties.

### BACKGROUND

Neural networks may be used in data compression and can be large in size. In some cases, neural networks may have hundreds of layers and millions or billions of parameters. Typically, a neural network will be trained and then transmitted to a decoding system. Even when compressed however, transmitting a full neural network model to a decoding system may require a large amount of bandwidth.

### SUMMARY

The present application relates to the field of data compression.

Embodiments of the present application provide methods for obtaining neural networks for use in data compression that overcome problems associated with conventional arrangements.

According to a first aspect, there is provided a method for obtaining a neural network for use in data compression. The method comprises initializing a decoder-side neural network at a decoding system; wherein the encoder-side and decoder-side neural networks have the same architecture and starting parameters; receiving, by the decoding system, the compressed training data item; and training decoder-side neural networks based upon the compressed training data item such that the encoder-side and decoder-side neural networks remain identical.

According to a second aspect, a method for obtaining a neural network for use in data compression is provided. The method includes: initializing an encoder-side neural network at an encoding system; wherein the encoder-side neural network has the same architecture and parameters as a corresponding decoder-side neural network; obtaining, by the encoding system, a training data item; encoding, by the encoding system, the training data item to generate a compressed training data item; transmitting, by the encoding system, the compressed training data item; and training, by the encoding system, the encoder-side neural network based upon the compressed training data item such that the encoder-side and decoder-side neural networks remain identical.

These and other aspects of the present application may become more readily apparent from the following description of the embodiments.

### BRIEF DESCRIPTION OF THE DRAWINGS

Embodiments will now be described, by way of example only, with reference to the accompanying drawings, in which:

FIG. 1 shows a flowchart of the operations of an encoding system according to a first embodiment;

FIG. 2 shows a flowchart of the operations of a decoding system according to the first embodiment;

FIG. 3 shows a schematic timing diagram of operations of the encoding and decoding systems according the first embodiment;

FIG. 4 is a continuation of FIG. 3 showing further operations of the encoding and decoding systems;

FIG. 5 shows a block diagram illustrating example operations of the encoding and decoding system according to a first neural network training phase;

FIG. 6 shows a block diagram illustrating example operations of the encoding system according to a second neural network training phase;

FIG. 7 shows a block diagram illustrating example operations for transmitting neural network parameter updates;

FIG. 8 shows a block diagram illustrating operations of an encoding and decoding system in use;

FIG. 9 shows a schematic illustration of a decoder according to various embodiments;

FIG. 10 shows a schematic illustration of an encoder according to various embodiments.

### DETAILED DESCRIPTION

Technical solutions in the embodiments of the present application will be described clearly and completely below with reference to the accompanying drawings.

These technical solutions may be applied to a H.265/HEVC or H.266/VVC video coding system (e.g. in an in-loop process where other filters such as an adaptive loop filter (ALF) and sample adaptive offset filter (SAO) are currently applied in such coding processes). However, it is to be understood that these technical solutions may applied in any other video coding system that involves video compression. Furthermore, while these principles are primarily illustrated with reference to video processing, they are also applicable to other data forms, including image processing or even audio processing.

A “video” in the embodiments refers to one or more pictures. In other words, a video can include one picture or a plurality of pictures. A picture may also be referred to as an “image”.

An “encoder” is a device capable of encoding data into a bitstream, while a “decoder” is a device capable of decoding the bitstream in order to obtain the encoded data, or an approximation of the encoded data. A “bitstream” comprises a sequence of bits.

“Intra-prediction” and “inter-prediction” are two prediction operations that can be used within the HEVC and VVC frameworks for a decoder to process a received bitstream in order to obtain the original signal. In the embodiments, “original signal” or “original video” is used to refer to the data prior to encoding at the encoder. A reference sample in the embodiments may refer to spatially and/or temporally spaced picture data used for the prediction of a picture (or region of a picture). Intra and inter-prediction operations are also used at the encoder to make rate-distortion decisions.

In more detail, intra-prediction involves the prediction of data spatially within a single picture, without a reference to other (temporally spaced) pictures. In other words, data for a first region of a picture is used in the prediction of the data for another region of the same picture, but there is no dependence on another temporally spaced picture. In this context, the data for the first region of the picture is considered a “reference sample”.

Inter-prediction involves the prediction of data between a plurality of temporally-spaced pictures. In other words, data for a first region of a first picture is used in the prediction of data for a second region of a second picture. The first and second region may or may not be spatially separated from one another. In this context, the data for the first region of the first picture is considered a “reference sample”. It is further noted that inter-prediction may sometimes use multiple reference regions from different pictures at once, i.e. for a single prediction operation.

A “residual” in the embodiments may refer to value obtained based on an original value of a region of a picture and a prediction value of the region of the picture (e.g. the difference between the original value and the predicted value).

A “block” in the embodiments may refer to a portion of a picture. For example, a picture may be portioned into two or more blocks. However, this is only an example. If a picture is not partitioned, then a “block” can refer to the entire picture.

A “filter” in the embodiments may refer to a filter that acts to enhance a signal.

In general, in the described embodiments, the filter is configured to sharpen blurred content, reduce ringing artifacts, and/or reduce blocking artifacts. However, embodiments are not limited to this and the filter can instead be configured to provide alternative or additional enhancements in other embodiments.

It should be understood that as used herein “data compression” refers to both the processes of encoding a digital signal and decoding a digital signal.

Neural networks may be used in data compression. For example, neural networks may be used in a post-processing phase of a decoding pipeline to reduce compression artifacts to enhance the quality of decompressed data. In another example, a neural network may be used within the encoding/decoding loop as an in-loop filter. Modern neural networks may be very large. In some cases, neural networks may have hundreds of layers and millions or billions of parameters. Typically, a neural network will be trained and then transmitted to a decoding system. Even when compressed however, transmitting a full neural network model to a decoding system may require a large amount of bandwidth.

The techniques described herein enable a neural network to be obtained with reduced bandwidth requirements. In general, identical neural networks are trained concurrently on both the encoding and decoding systems using compressed training data provided by the encoding system. The encoder-side neural network may then be fine-tuned using training data without compression or at higher quality level of compression. An update to the decoder-side neural network to match the fine-tuned encoder-side neural network can be determined and transmitted to the decoding system. In this way, the bandwidth requirement for providing a neural network to the decoding system is reduced. The method may be particularly useful where bandwidth is limited, for example, where transmitting high-quality training data and/or a full neural network model is prohibitive.

The neural network may be any appropriate type of neural network having any appropriate architecture. For example, the neural network may comprise convolutional layers, attention layers, residual blocks, and recurrent layers amongst others.

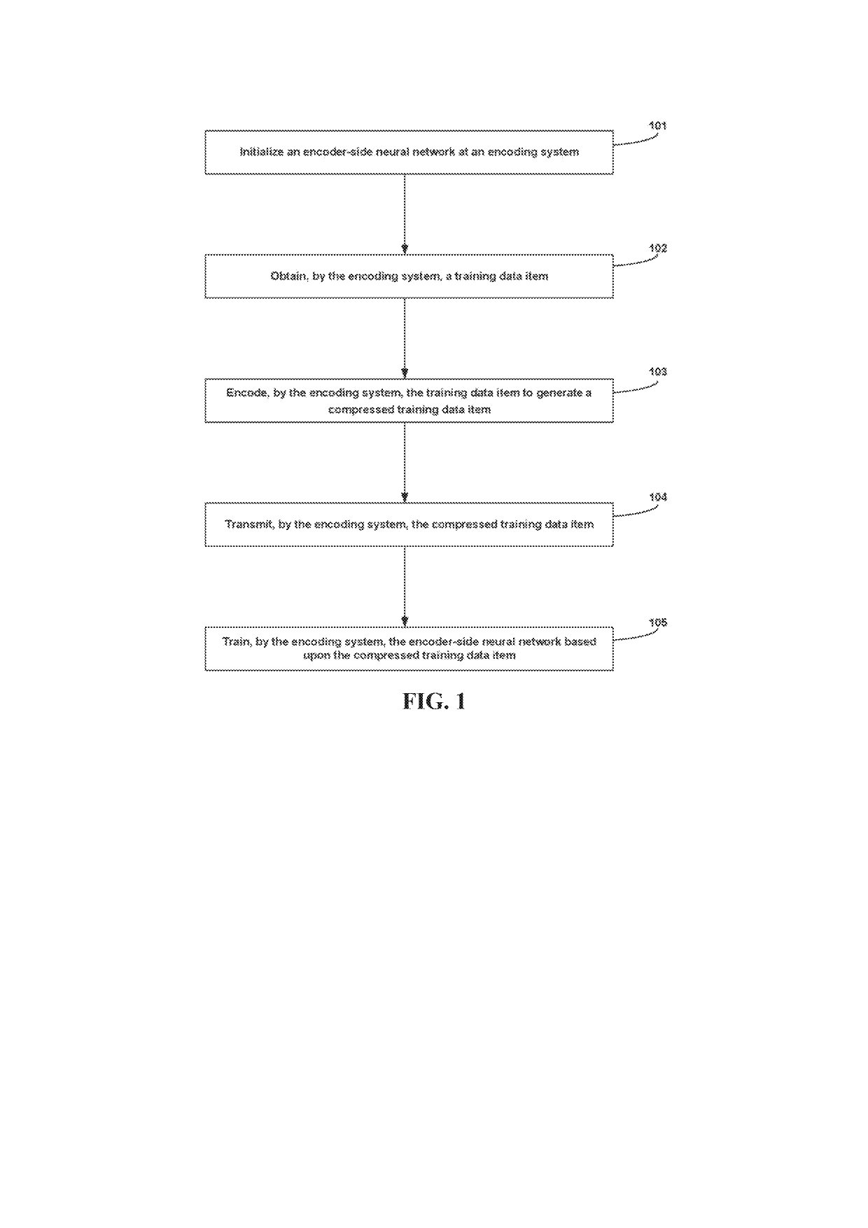

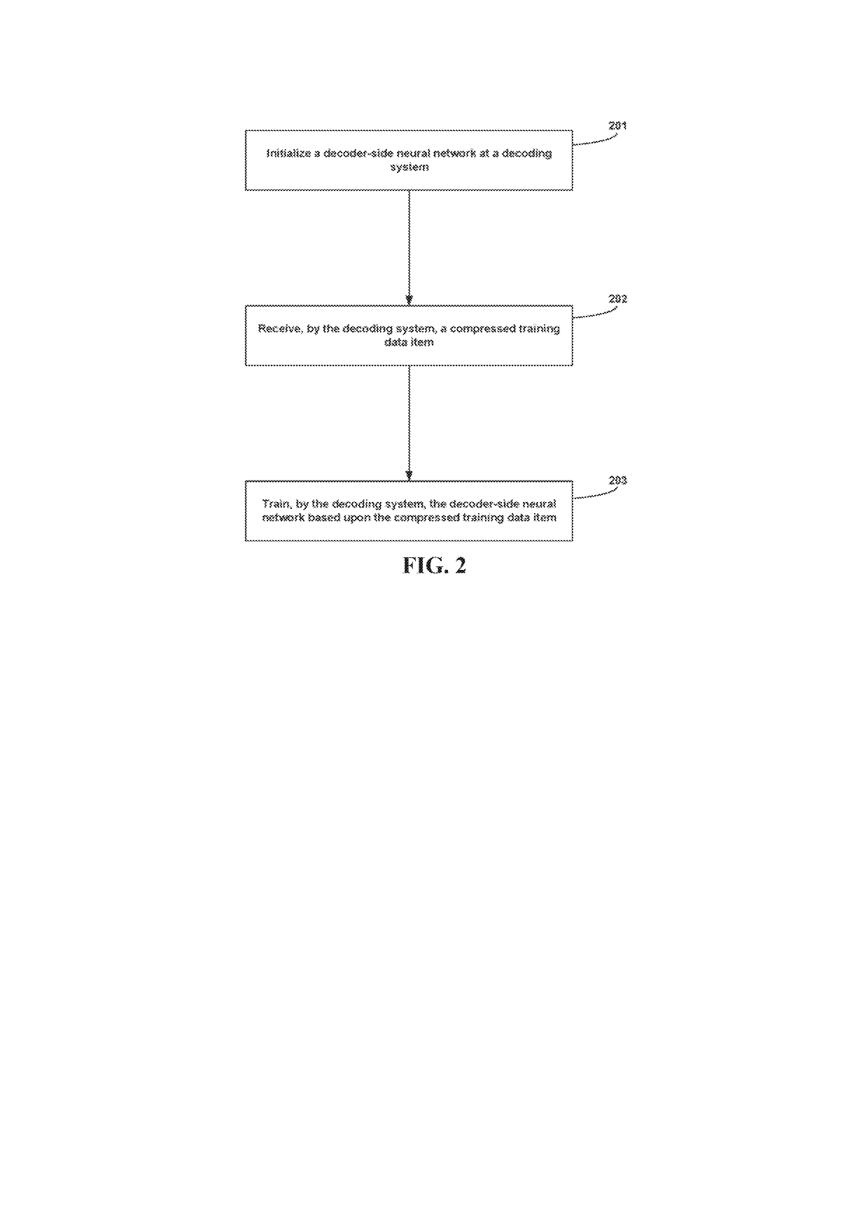

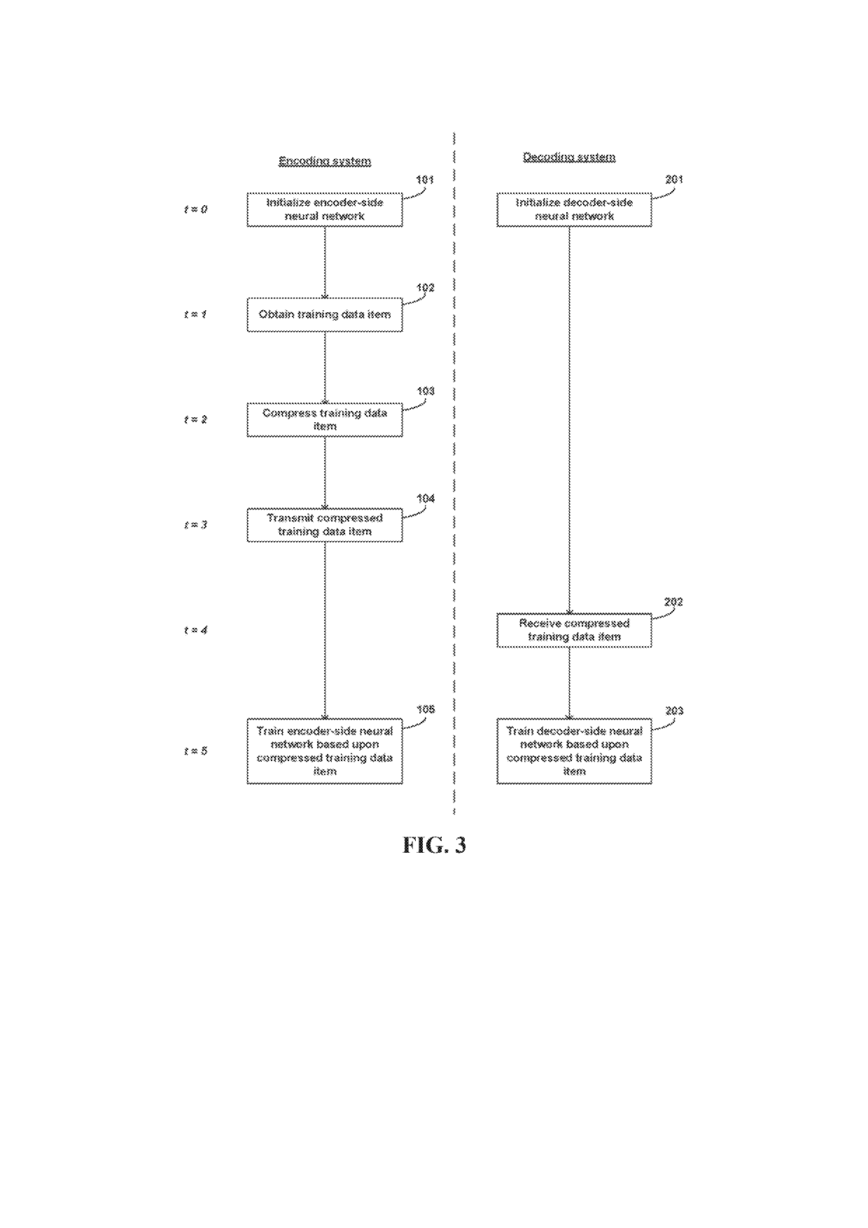

FIG. 1 shows a flowchart of the operations of an encoding system according to a first embodiment. FIG. 2 shows a flowchart of the operations of a decoding system according to the first embodiment. FIG. 3 shows schematic timing diagram of operations of the encoding and decoding system according to the first embodiment.

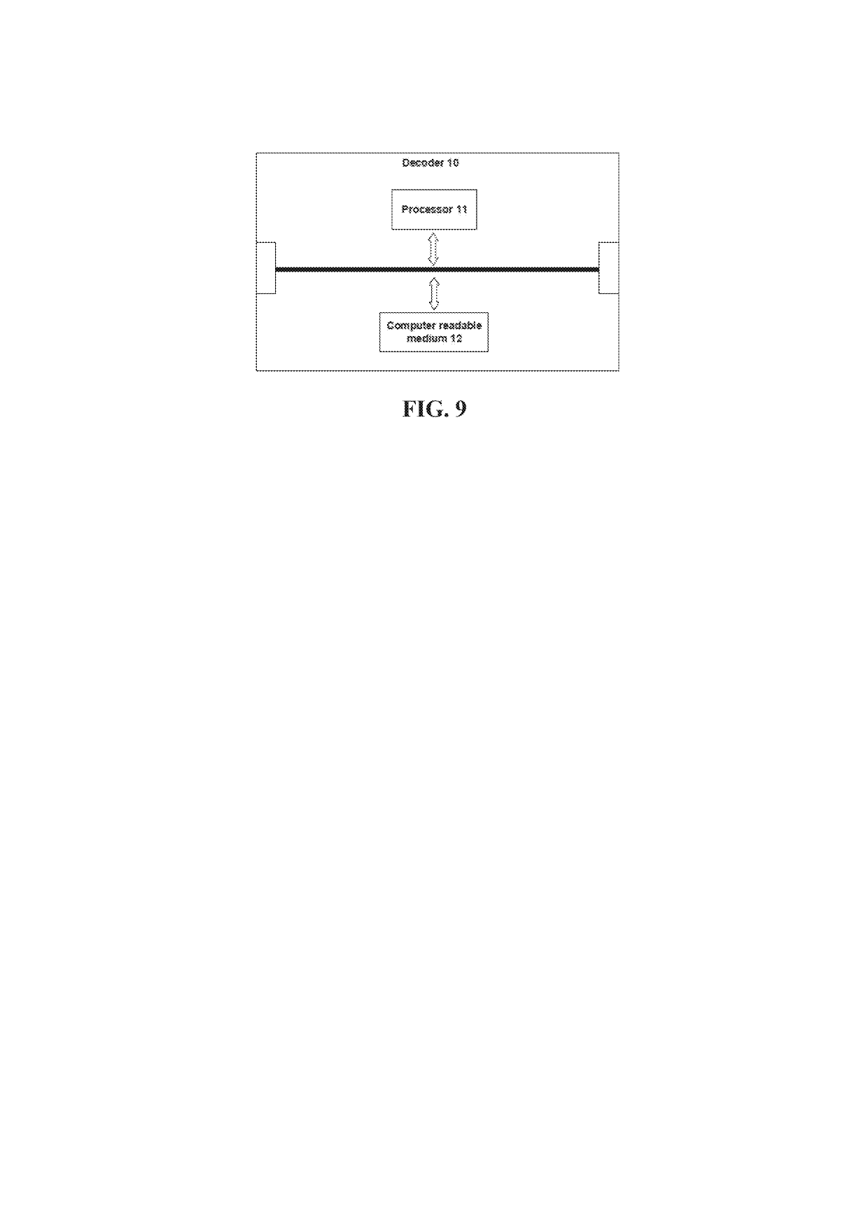

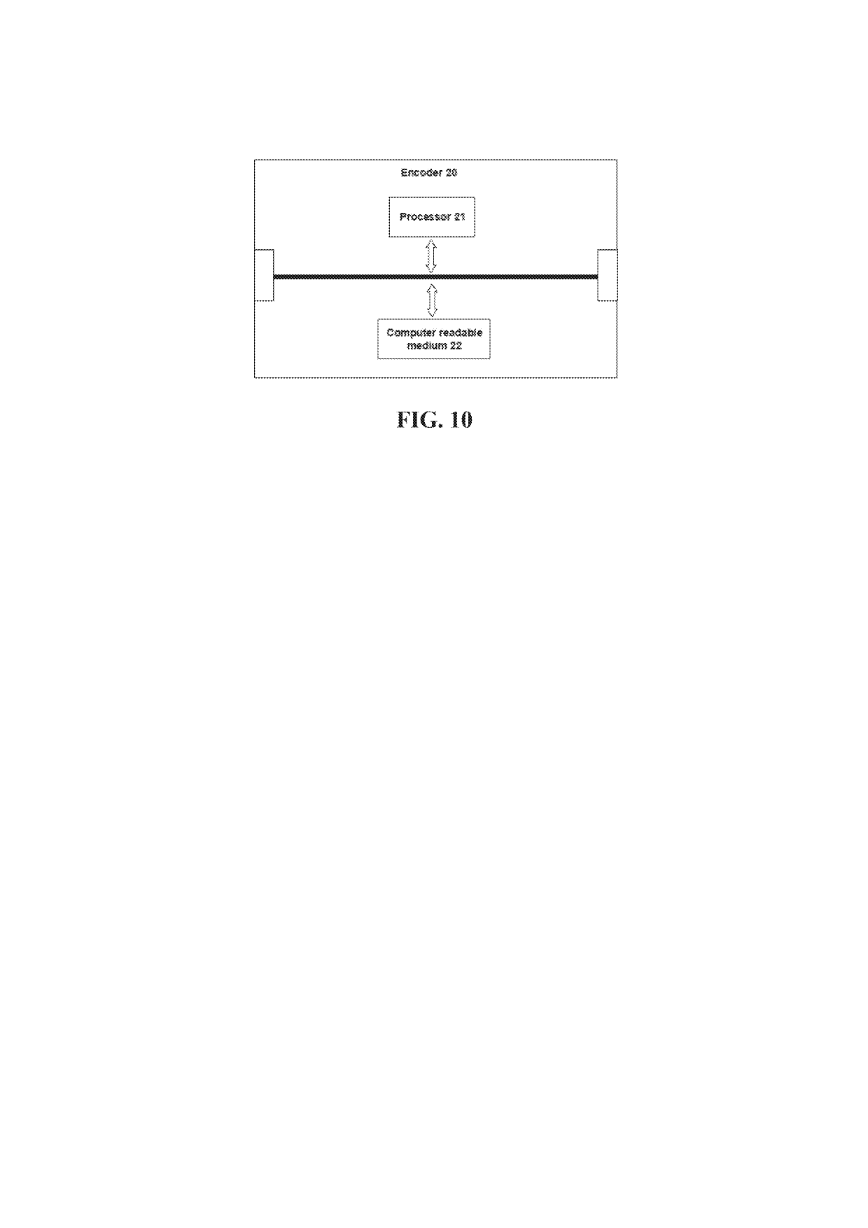

The operations of FIGS. 1 and 2 may be implemented by one or more processors in one or more locations. For example, the operations of FIG. 1 may be implemented by an encoder 20 shown in FIG. 10 and the operations of FIG. 2 may be implemented by a decoder 10 shown in FIG. 9.

The flowchart of FIG. 1 starts at step 101, in which an encoder-side neural network is initialized. The encoder-side neural network is initialized identically to a corresponding decoder-side neural network. Thus, both encoder-side and decoder-side neural networks have the same architecture and starting parameters. The initialization procedure may be pre-agreed between the encoding and decoding systems or the encoding system may transmit data indicating the architecture, activation functions, hyperparameters, random seed or any other necessary data for initializing a neural network.

At step 102, the encoding system obtains a training data item. The training data item may be obtained from local storage or may be obtained from a remote system via a network connection. The training data item may be any type of digital signal such as an image, video or audio signal. The training data item may be part of an appropriate training dataset for training the neural network to carry out a particular task relating to data compression. Example tasks are described below.

At step 103, the encoding system compresses the training data item. The training data item may be compressed according to any appropriate compression algorithm. This may depend on the type of training data item. For example, an image may be encoded and compressed in JPEG format, image/video data may be compressed using the H.265/HEVC algorithm or H.266/VVC algorithm, audio data may be compressed using the AAC algorithm. However, it will be appreciated that embodiments are not limited to these examples. The quality level of the compression may be dependent on a bandwidth criterion, such as the available bandwidth for transmitting the compressed training data to the decoding system. For example, a “medium” quality setting may be used.

At step 104, the encoding system transmits the compressed training data item to the decoding system. The compressed training data item may be transmitted over any appropriate network connection.

At step 105, the encoder-side neural network is trained based upon the compressed training data. The encoder-side neural network is trained using the same training algorithm and settings as the decoder-side neural network so as to obtain identical versions of the neural network on both the encoding and decoding systems. The training algorithm and settings may be pre-agreed between the encoding and decoding systems, or the encoding system may transmit data indicative of the training algorithm to be used and/or any particular hyperparameters such as a learning rate. The neural network may be trained using any appropriate training algorithm such as stochastic gradient descent.

The neural network may be trained to perform any appropriate encoding/decoding operation. Generally, the neural network is configured to perform a filtering, enhancement, or refinement operation. For example, the neural network may be configured to reduce compression artifacts and/or distortions. For image/video data, artifacts/distortions may include blocking, blurring, or ringing artifacts. In another example, the neural network may be configured to perform supersampling (or upscaling). For audio data, artifacts/distortions may include ringing, echo, “birdie artifacts”, drop-outs, rattling, warbling, and hissing amongst others. However, it will be appreciated that embodiments are not limited to any particular example operation.

The encoding system may repeat steps 102 to 105 to obtain further training data items, compress and transmit the further training data items and to continue training the neural network on the further compressed training data items. In addition, the encoding system may carry out training of the neural network in parallel with obtaining, compressing and transmitting of the training data items, or alternatively, all of the training data items may be obtained, compressed and transmitted prior to starting training.

The training may be performed for a plurality of passes over the training data items until a particular stopping criterion is reached. For example, a threshold number of training steps have been carried out or until the neural network has sufficiently converged.

FIG. 2 shows a flowchart of corresponding operations at a decoding system. At step 201, a decoder-side neural network is initialized. As discussed above, the decoder-side neural network is initialized identically to a corresponding encoder-side neural network. Thus, both encoder-side and decoder-side neural networks have the same architecture and starting parameters. The initialization procedure may be pre-agreed between the encoding and decoding systems or data indicating the architecture, activation functions, hyperparameters, random seed or any other necessary data for initializing a neural network may be received from the encoding system. Alternatively, the initialization procedure may be determined by the decoding system and any necessary data transmitted from the decoding system to the encoding system.

At step 202, the decoding system receives a compressed training data item. At step 203, the decoding system trains the decoder-side neural network based upon the compressed training data item. As discussed above, the decoding system uses the same training algorithm and settings as the encoding system so as to obtain identical versions of the neural network on both the encoding and decoding systems. The training algorithm and settings may be pre-agreed between the encoding and decoding systems, or the decoding system may receive data from the encoding system indicating the training algorithm to be used and/or any particular hyperparameters such as a learning rate. Alternatively, the decoding system may determine the training algorithm and transmit any necessary data to the encoding system.

The decoding system may repeat steps 202 and 203 if there is further training data for which to train the neural network using. Thus, the decoding system may receive further compressed training data items and continue to train the neural network using the further compressed training data items. The received compressed training data items may be stored locally at the decoding system. For example, the training may continue for a plurality of passes over the received compressed training data items until a particular stopping criterion is reached. For example, a threshold number of training steps have been carried out or until the neural network has sufficiently converged. In addition, the decoding system may receive further compressed training data items in parallel to carrying out training. Alternatively, all of the compressed training data items may be received prior to starting training. The neural network may be trained using any appropriate training algorithm such as stochastic gradient descent.

As discussed above, the neural network may be trained to perform any appropriate encoding/decoding operation. Generally, the neural network is configured to perform a filtering, enhancement, or refinement operation. For example, the neural network may be configured to reduce compression artifacts and/or distortions. For image/video data, artifacts/distortions may include reducing blocking, blurring, or ringing artifacts. In another example, the neural network may be configured to perform supersampling (or upscaling). For audio data, artifacts/distortions may include ringing, echo, “birdie artifacts”, drop-outs, rattling, warbling, and hissing amongst others. However, it will be appreciated that embodiments are not limited to any particular example operation.

FIG. 3 shows a schematic timing diagram of the operations of the encoding and decoding systems described above. It will be appreciated that the timings are illustrative and not to scale.

In FIG. 3, initialization of the encoder-side neural network (step 101) and initialization of the decoder-side neural network (step 201) are carried out concurrently at time t=0.

At time steps t=1 to t=3, the encoding system obtains a training data item (step 102), compresses the training data (step 103) and transmits the compressed training data item to the decoding system (step 104). At time step t=4, the decoding system receives the compressed training data item (step 202).

At time step t=5, the encoding and decoding systems train their respective neural networks based upon the compressed training data item (steps 105 and 203).

Whilst FIG. 3 shows certain steps as being carried out simultaneously, it will be appreciated that exact synchronicity is not required. For example, the encoding system may start training of the encoder-side neural network at time step t=4 immediately following transmittal of the compressed training data item or the training may be carried out in parallel to the transmittal. In another example, the decoding system may initialize the decoder-side neural network at any time prior to training the decoder-side neural network. For example, the initialization may be triggered in response to receiving a compressed training data item. As such, the operations of the encoding and decoding system may be carried out asynchronously. Embodiments are not limited to the particular order shown in FIG. 3.

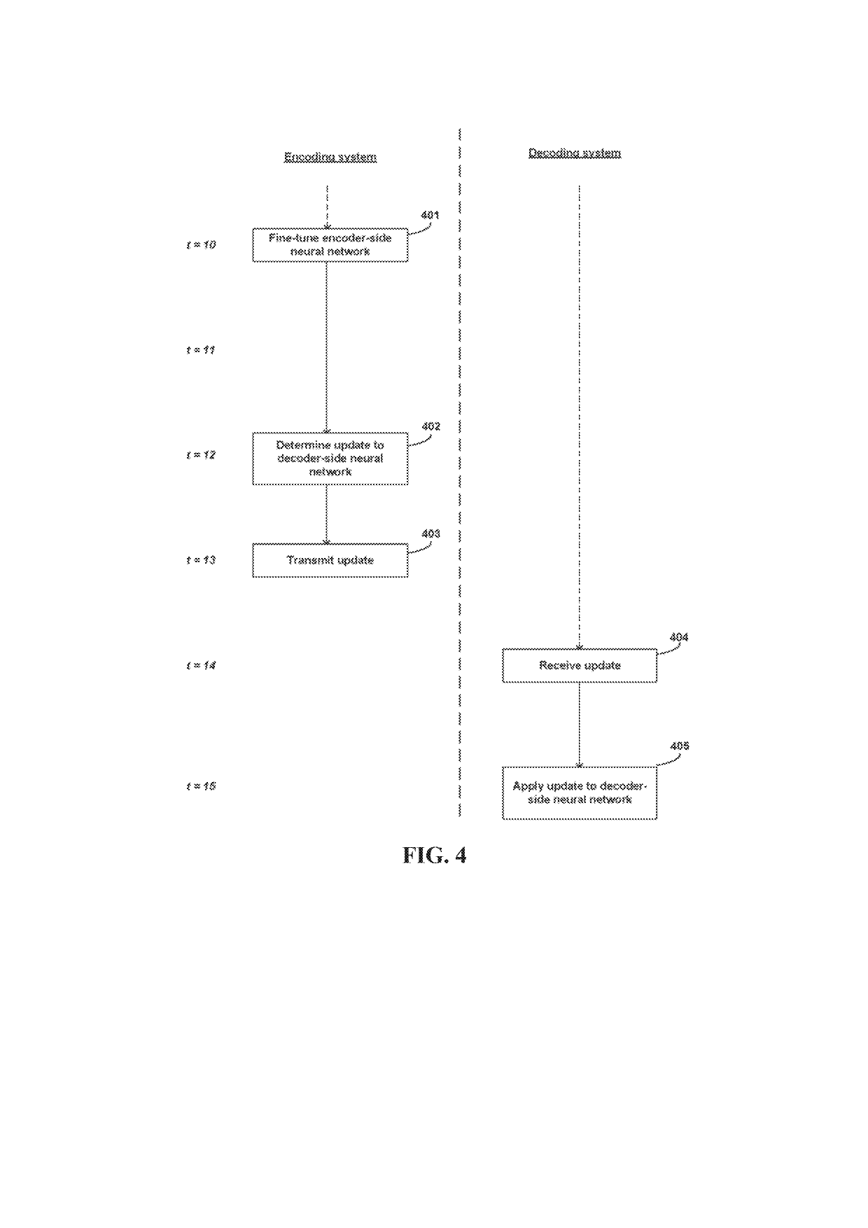

FIG. 4 is a continuation of FIG. 3 and shows further operations of the encoding and decoding systems. After training is completed on the encoding system, a second phase of training, referred to as “fine-tuning” may be started.

In FIG. 4, at time step t=10, the encoding system fine-tunes the encoder-side neural network (step 401). As described in further detail below, the fine-tuning may be based upon the original training data items without compression or at a higher quality level of compression than that of the earlier first training phase. The decoder-side neural network does not undergo a fine-tuning training phase. The parameters of the decoder-side neural network are maintained without modification during this time. In some embodiments, the available bandwidth may be limited such that transmittal of high-quality training data items and/or a full neural network model may be prohibitive.

A more detailed example of fine-tuning the encoder-side neural network is provided below. However, in general, fine-tuning comprises processing, by the encoder-side neural network, a fine-tuning input to the encoder-side neural network based upon decoding a compressed fine-tuning training data item to generate a first fine-tuning network output, and adjusting the parameters of the encoder-side neural network based upon the fine-tuning network output and a corresponding fine-tuning target output. As discussed above, fine-tuning may be carried out using the same training data items as in the first training phase. Thus, in one example, the fine-tuning input is the reconstructed training data item generated by decoding the compressed training data item and the fine-tuning target output is the original training data item itself. In another example, the fine-tuning input is an intermediate decoding output generated during decoding of the compressed training data item.

Alternatively, fine-tuning may be carried out using additional training data separate from the first training phase. Thus, in one example, the fine-tuning input is a second reconstructed training data item generated by encoding and decoding a second training data item. The fine-tuning target output is the original second training data item. In another example, the fine-tuning input is an intermediate decoding output generated during decoding of the second compressed training data item. Alternatively, fine-tuning may use a combination of the same training data and additional training data.

The fine-tuning may be performed for a plurality of passes over the data items for fine-tuning until a particular stopping criterion is reached. For example, a threshold number of fine-tuning steps have been carried out or until the neural network has sufficiently converged.

Referring back to FIG. 4, at time step t=12, the encoding system determines an update to the decoder-side neural network based upon the parameters of the fine-tuned encoder-side neural network and the parameters prior to fine-tuning (step 402). That is, prior to fine-tuning, the encoder-side neural network should be identical to the decoder-side neural network. The encoding system may compute a differential between the fine-tuned encoder-side neural network and the encoder-side neural network prior to fine-tuning so as to provide an update to the decoder-side neural network to match the fine-tuned encoder-side neural network.

At time step t=13, the encoding system transmits the update to the decoding system (step 403) and at time step t=14, the decoding system receives the update (step 404). At time step t=15, the decoding system applies the update to the decoder-side neural network. Thus, the decoder-side neural network matches the encoder-side neural network after having applied the update and the decoding system obtains a fine-tuned neural network using limited bandwidth. In one example, the update may undergo compression prior to transmittal to further reduce the bandwidth necessary.

The training task in the first training phase may be the same or different to the training task in the fine-tuning phase. For example, in the first training phase, an unsupervised learning task may be used for training the neural network(s). In the fine-tuning phase, a supervised learning task may be used. In another example, the fine-tuning may be limited to a subset of layers of the neural network, for example, top N layers may be adjusted whilst the remaining layers are held fixed. In a further example, the fine-tuning may train an additional layer whilst all previous layers remain fixed. It will be appreciated that embodiments are not limited to any particular example.

Fine-tuning may be carried out using an online or continuous learning framework. That is, the neural network may continue training whilst it is deployed. In this regard, further updates to the decoder-side neural network may be transmitted together with compressed data items that are to be decoded by the decoding system. The decoding system may apply the update to the decoder-side neural network prior to decoding the compressed data item so that the updated decoder-side neural network is used in the decoding process. It will be appreciated that embodiments are not limited to any particular training framework.

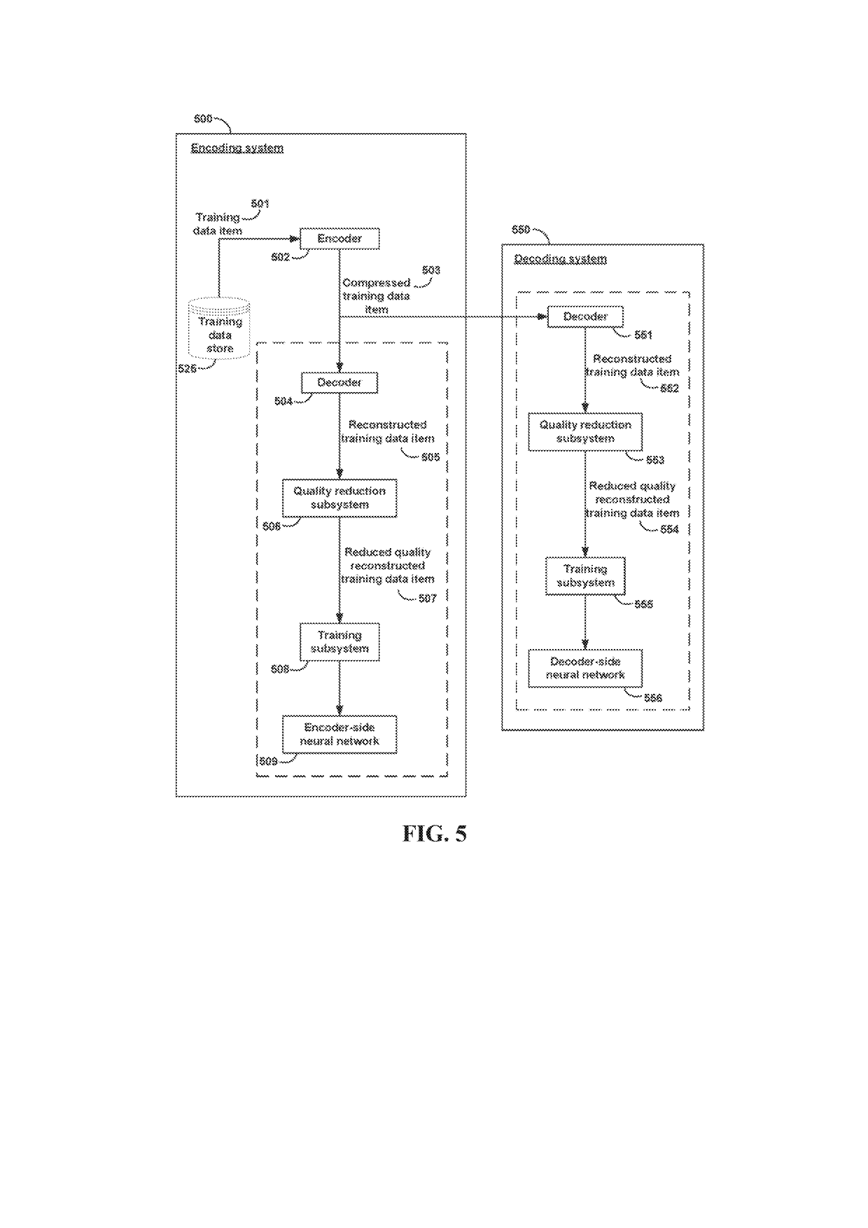

FIG. 5 shows a block diagram illustrating an example encoding and decoding system according to the embodiment of FIGS. 1-3 discussed above. In this example, the neural network operates in a post-processing phase of a decoding pipeline. The neural network is configured to perform enhancement or refinement of the output of a decoder, for example, in order to reduce compression artifacts or distortions as described above.

In FIG. 5, an encoding system 500 is configured to obtain a training data item 501 from a training data store 525. The encoding system 500 comprises an encoder 502 configured to compress the training data item 501 to generate a compressed training data item 503. As discussed above, the encoder 502 may implement any appropriate data compression algorithm. For example, an image may be encoded and compressed in JPEG format, image/video data may be compressed using the H.265/HEVC algorithm or H.266/VVC algorithm, audio data may be compressed using the AAC algorithm. However, it will be appreciated that embodiments are not limited to these examples.

The encoding system 500 is configured to transmit the compressed training data item 503 to a decoding system 550. The encoding system 500 and the decoding system 550 further comprise an identical set of elements highlighted by the dashed boxes. These include a decoder 504/551, a quality reduction subsystem 506/553, a training subsystem 508/555 and a neural network 509/556. These identical elements ensure that the neural networks 509/556 on the encoding and decoding systems at the end of the first training phase are identical. For brevity, the elements of the encoding system 500 will be described, however, it will be appreciated that the same operations will be carried out by the corresponding elements of the decoding system 500.

The decoder 504 is configured to decompress the compressed training data item 503 to generate a reconstructed training data item 505. The quality reduction subsystem 506 is configured to modify the reconstructed training data item 505 to reduce the quality of the reconstructed training data item 505. For example, the quality reduction subsystem 506 may be configured to modify the reconstructed training data item 505 to introduce compression artifacts and/or distortions. As discussed above, these may include blocking, blurring, or ringing artifacts for image/video data or ringing, echo, “birdie artifacts”, drop-outs, rattling, warbling, and hissing amongst others for audio data. For example, one or more types of artifact/distortion may be selected at random and applied to one or more randomly chosen locations of the reconstructed training data item 505. In another example, the quality reduction subsystem 506 may apply a downsampling, compression or quantization at a lower quality setting.

The training subsystem 508 is configured to carry out training operations for training the neural network 509. In particular, the reconstructed training data item 505 (prior to quality reduction) is used as a target output for training the neural network. In this way, the neural network is trained to enhance the quality of its input signal and may be used to reduce compression artifacts and distortions. The reduced quality reconstructed training data item 507 is processed by the neural network 509 to generate a network output. The network output and the target output (the reconstructed training data item 505) may be compared. A loss function based upon the comparison may be used to determine error values for which updates to the neural network may be determined. For example, backpropagation and stochastic gradient descent may be used to determine the parameter update(s). Any appropriate loss function may be used, for example, the mean-squared error or the cross-entropy error may be used. It will be appreciated that embodiments are not limited to any particular loss function or method for determining parameter updates.

As discussed above, the decoder 551, quality reduction subsystem 553 and training subsystem 555 of the decoding system 550 are configured identically to obtain an identical neural network 556 at the decoding system 550. In some embodiments, the available bandwidth may be limited such that transmitting high quality training data items and/or a full neural network model to the decoding system may be prohibitive.

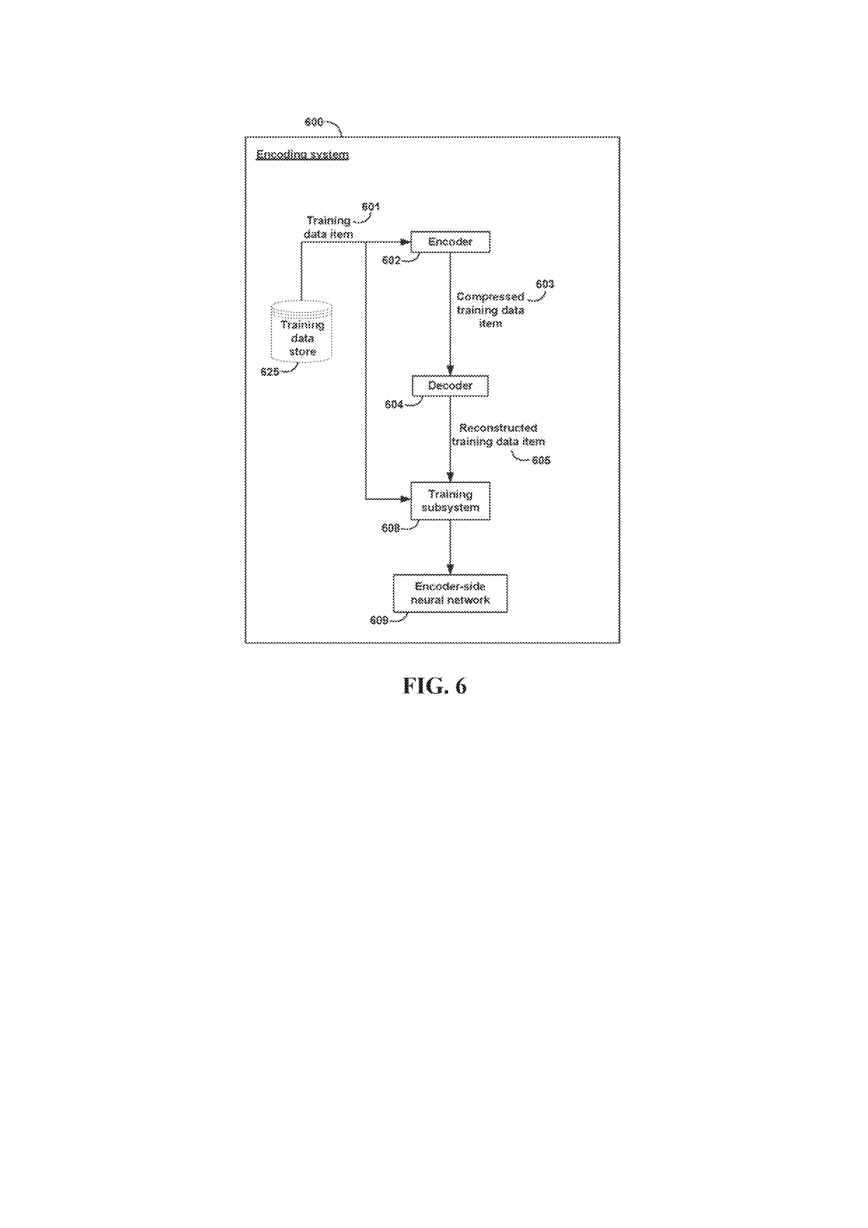

FIG. 6 shows a block diagram of an example encoding system for carrying out fine-tuning such as that described above with reference to FIG. 4. FIG. 6 shows an encoding system 600 which may be the same as the encoding system 500 in FIG. 5. In FIG. 6, the encoding system 600 is configured to obtain a training data item 601 from a training data store 625. As discussed above, the training data item 601 may be a training data item that has been used in the first training phase or may be a new training data item for use specifically in the fine-tuning phase.

Similar to FIG. 5, the encoding system 600 in FIG. 6 comprises an encoder 602 configured to compress the training data item 601 and a decoder 604 configured to decompress the compressed training data item 603 to generate a reconstructed training data item 605. For fine-tuning however, the reconstructed training data item 603 is processed by the encoder-side neural network 609 to generate a network output. The training subsystem 608 is configured to use the original training data item 601 as the target output for the neural network 609. In this way, the encoder-side neural network 609 is fine-tuned on higher quality data and is trained to reduce artifacts/distortions that arise from the encoding/decoding process to enhance the quality of the reconstruction.

The same training algorithm may be used in the fine-tuning phase as in the first training phase where appropriate. That is, the network output and the target output (the training data item 601) may be compared. A loss function based upon the comparison may be used to determine error values for which updates to the neural network may be determined. For example, backpropagation and stochastic gradient descent may be used to determine the parameter update(s). Any appropriate loss function may be used, for example, the mean-squared error or the cross-entropy error may be used. In other examples, the fine-tuning task may be different to the task in the first training phase and hence the training algorithm may be different between the two phases. It will be appreciated that embodiments are not limited to any particular loss function or method for determining parameter updates.

In one example, the fine-tuning may be limited to a subset of layers of the neural network, for example, top N layers may be adjusted whilst the remaining layers are held fixed. In another example, the fine-tuning may train an additional layer whilst all previous layers remain fixed. It will be appreciated that embodiments are not limited to any particular example.

The fine-tuning may be performed for a plurality of passes over the data items for fine-tuning until a particular stopping criterion is reached. For example, a threshold number of fine-tuning steps have been carried out or until the neural network has sufficiently converged.

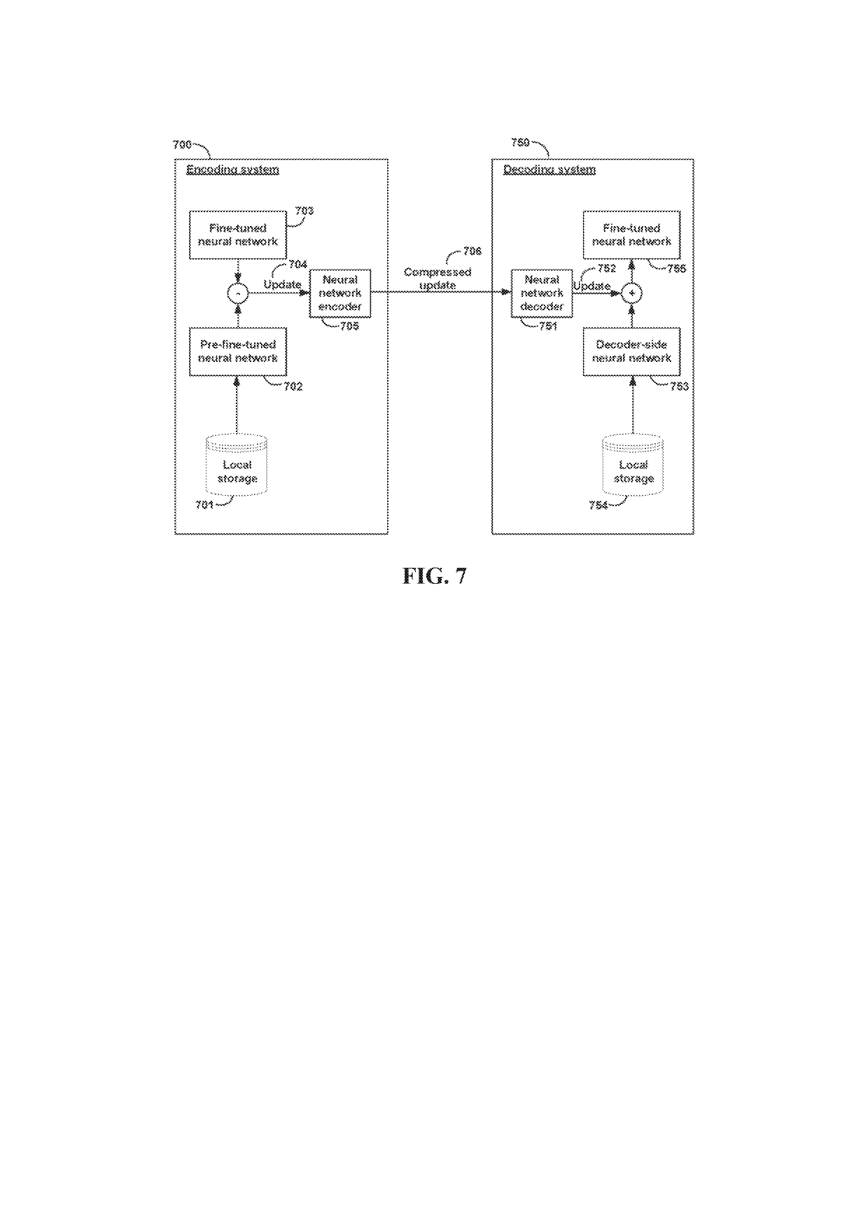

FIG. 7 shows a block diagram of an example for updating the decoder-side neural network after the encoder-side neural network has been fine-tuned. FIG. 7 shows an encoding system 700 which may be same as the encoding systems 500/600 in FIGS. 5 and 6. FIG. 7 also shows a decoding system 750 which may be the same as decoding system 550 in FIG. 5.

The encoding system 700 is configured to retrieve from local storage 701 a previous version of the pre-fine-tuned neural network 702 at encoding side. This version of the pre-fine-tuned neural network 702 at encoding side is expected to be the same as the current version of the decoder-side neural network 753 as the decoder-side neural network does not undergo fine-tuning.

The encoding system 700 is further configured to determine an update 704 based upon the fine-tuned neural network 703 at encoding side and the retrieved pre-fine-tuned neural network 702 at encoding side. The encoding system 700 may compute a differential between the parameters of the two networks.

The encoding system 700 further comprises a neural network encoder 705 configured to compress the determined update 704. An update, such as a differential, may compress better as compared to a full neural network. The encoding system 700 is configured to transmit the compressed update 706 to the decoding system 750.

The decoding system 750 is configured to receive the compressed update 706. The decoding system 750 comprises a neural network decoder 751 which is configured to decompress the compressed update 706. The decoding system 750 is further configured to retrieve the decoder-side neural network 753 from local storage 754. The decoding system 750 is configured to apply the decompressed update 752 to the decoder-side neural network 753 in order to obtain a fine-tuned neural network 755 at the decoding system 750.

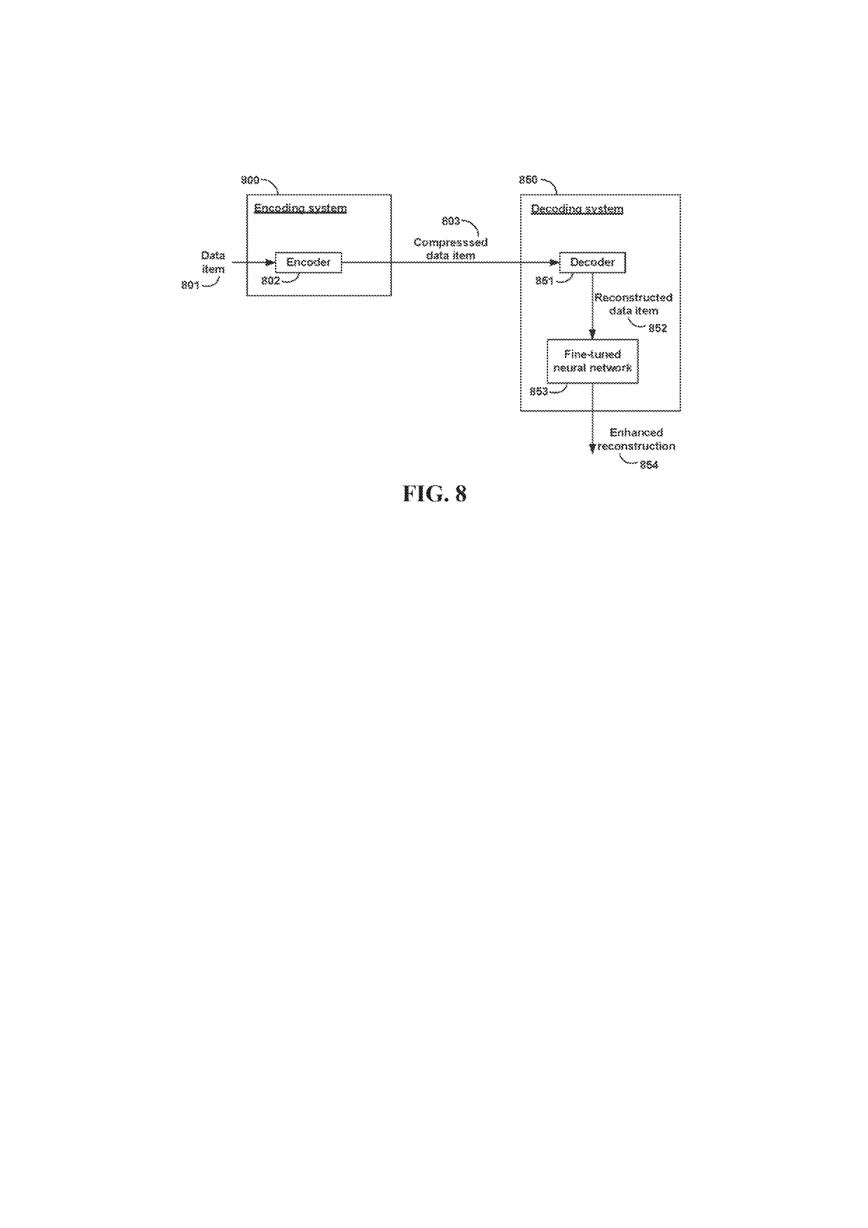

FIG. 8 shows a block diagram of the encoding and decoding systems in use after the decoder-side neural network has been updated. FIG. 8 shows an encoding system 800 which may be the same as the encoding systems in FIGS. 5 to 7. FIG. 8 shows a decoding system 850 which may be the same as the decoding systems in FIGS. 5 and 7.

The encoding system 800 is configured to receive a data item 801 that is to be transmitted to a remote device/decoding system 850. The encoding system 800 comprises an encoder 802 configured to generate a compressed data item 803 using any appropriate compression algorithm as discussed above. The encoding system 800 is configured to transmit the compressed data item 803 to the decoding system 850.

The decoding system 850 is configured to receive the compressed data item 803 and comprises a decoder 851 configured to decompress the compressed data item 803 to reconstruct the data item. The decoding system 850 comprises a fine-tuned neural network 853 that is configured to process the reconstructed data item 852 to generate an enhanced reconstruction 854 as output of the decoding system 850.

As discussed above, the neural network may continue to be fine-tuned whilst in use through online/continuous learning. In this regard, encoding system 800 may be configured as per the encoding system 700 in FIG. 7. The encoding system 800 maintains its own copy of the fine-tuned neural network and is configured to also decode the received data item 801. The encoding system 800 is configured to fine-tune the encoder-side neural network based upon the received data item and the reconstructed data item. This online learning version of fine-tuning may involve the same training processes as the fine-tuning described above.

The encoding system 800 is configured to determine an update to the decoder-side neural network based upon the new parameters from this latest round of fine-tuning and the parameters prior to this round of fine-tuning. The encoding system 800 is configured to transmit the update to the decoding system 850. The update may be compressed prior to transmittal.

The decoding system 800 is configured to receive the update as well as the compressed data item 803 for decoding. The decoding system 800 is configured to apply the update to the fine-tuned neural network 853 at decoding side prior to decoding the compressed data item 803. Once updated, the decoding system 800 is configured to decode the compressed data item 803 using the updated fine-tuned neural network 853 at decoding side.

Whilst the above examples in FIGS. 5 to 8 describe a neural network for use in the post-processing phase of a decoding pipeline, it will be appreciated that embodiments are not limited to these examples. In particular, the neural network may be for use in the encoder/decoder loops. For example, the neural network may carry out in-loop filtering or enhancement operations. In this regard, the training of the neural networks in both phases may be based upon any intermediate decoding outputs with appropriate targets.

FIG. 9 shows a schematic illustration of a decoder 10 according to an embodiment. Specifically, FIG. 9 shows a schematic illustration of a decoder 10 configured to perform any of the decoding system operations discussed herein. Such detailed descriptions thereof are omitted here for brevity.

As shown in FIG. 9, the decoder 10 comprises a processor 11 and a computer readable medium 12. The processor 11 and the computer readable medium 12 may be connected via a bus system. The computer readable medium is configured to store programs, instructions or codes. The processor 11 is configured to execute the programs, the instructions or the codes in the computer readable medium 12 so as to perform any operation of any decoding system disclosed herein.

Hence, in embodiments, the computer readable medium 12 is configured to store a computer program capable of being run in the processor 11, and the processor 11 is configured to run the computer program to perform any operation of any decoding system discussed herein.

FIG. 10 shows a schematic illustration of an encoder 20 according to an embodiment. Specifically, FIG. 10 shows a schematic illustration of an encoder 20 configured to perform any of the encoding system operations discussed herein. Such detailed descriptions thereof are omitted here for brevity.

As shown in FIG. 10, the encoder 20 comprises a processor 21 and a computer readable medium 22. The processor 21 and the computer readable medium 22 may be connected via a bus system. The computer readable medium is configured to store programs, instructions or codes. The processor 21 is configured to execute the programs, the instructions or the codes in the computer readable medium 22 so as to perform any operation of any encoding system discussed herein.

Hence, in embodiments, the computer readable medium 22 is configured to store a computer program capable of being run in the processor 21, and the processor 21 is configured to run the computer program to perform any operation of any encoding system discussed herein.

Embodiments can also provide a computer-readable medium having computer-executable instructions to cause one or more processors of a computing device to carry out the method of any of the embodiments.

Examples of computer-readable media include both volatile and non-volatile media, removable and non-removable media, and include, but are not limited to: solid state memories; removable disks; hard disk drives; magnetic media; and optical disks. In general, the computer-readable media include any type of medium suitable for storing, encoding, or carrying a series of instructions executable by one or more computers to perform any of one or more of the processes and features described herein.

It will be appreciated that the functionality of each of the components discussed can be combined in a number of ways other than those discussed in the foregoing description. For example, in some embodiments, the functionality of more than one of the discussed devices can be incorporated into a single device. In other embodiments, the functionality of at least one of the devices discussed can be split into a plurality of separate (or distributed) devices.

Conditional language such as “may”, is generally used to indicate that features/steps are used in a particular embodiment, but that alternative embodiments may include alternative features, or omit such features altogether.

Furthermore, the method steps are not limited to the particular sequences described, and it will be appreciated that these can be combined in any other appropriate sequences. In some embodiments, this may result in some method steps being performed in parallel. In addition, in some embodiments, particular method steps may also be omitted altogether.

While certain embodiments have been discussed, it will be appreciated that these are used to exemplify the overall teaching of the present invention, and that various modifications can be made without departing from the scope of the invention. The scope of the invention should is to be construed in accordance with the appended claims and any equivalents thereof.

Many further variations and modifications will suggest themselves to those versed in the art upon making reference to the foregoing illustrative embodiments, which are given by way of example only, and which are not intended to limit the scope of the invention, that being determined by the appended claims.

1. A method for obtaining a neural network for use in data compression, the method comprising:
initializing a decoder-side neural network at a decoding system;
wherein the decoder-side neural network has the same architecture and parameters as a corresponding encoder-side neural network;
receiving, by the decoding system, a compressed training data item; and
training, by the decoding system, the decoder-side neural network based upon the compressed training data item such that the encoder-side and decoder-side neural networks remain identical.

2. The method of claim 1, further comprising:
receiving, by the decoding system, an update for the decoder-side neural network; and
updating, by the decoding system, the decoder-side neural network based upon the received update.

3. The method of claim 1, wherein training the decoder-side neural networks comprises:
decoding the compressed training data item to generate a reconstructed training data item;
generating an input to the decoder-side neural network based upon the decoding;
processing, by the decoder-side neural network, the input to the neural network to generate a network output; and
adjusting the parameters of the decoder-side neural network based upon the generated network output and a corresponding target output based upon the decoding.

4. The method of claim 3, wherein generating an input to the decoder-side neural network based upon the decoding comprises:
modifying the reconstructed training data item to reduce the quality of the reconstructed training data item; and
providing the reduced quality reconstructed training data item as the input to the decoder-side neural network; and
wherein the reconstructed training data item is the target output of the decoder-side neural network.

5. The method of claim 4, wherein modifying to reduce quality comprises modifying to introduce at least one of compression artifacts or distortions.

6. The method of claim 3, wherein generating an input to the decoder-side neural network is based upon an intermediate decoding output generated during decoding of the compressed data item.

7. The method of claim 1, further comprising:
receiving, by the decoding system, a second update and a compressed data item;
updating, by the decoding system, the decoder-side neural network based upon the received second update; and
decoding, by the decoding system and using the updated decoder-side neural network, the compressed data item.

8. A method for obtaining a neural network for use in data compression, the method comprising:
initializing an encoder-side neural network at an encoding system;
wherein the encoder-side neural network has the same architecture and parameters as a corresponding decoder-side neural network;
obtaining, by the encoding system, a training data item;
encoding, by the encoding system, the training data item to generate a compressed training data item;
transmitting, by the encoding system, the compressed training data item; and
training, by the encoding system, the encoder-side neural network based upon the compressed training data item such that the encoder-side and decoder-side neural networks remain identical.

9. The method of claim 8, further comprising:
fine-tuning, by the encoding system, the encoder-side neural network.

10. The method of claim 9, further comprising:
determining, by the encoding system, an update to the decoder-side neural network based upon the parameters of the fine-tuned encoder-side neural network and the parameters of encoder-side neural network prior to fine-tuning; and
transmitting, by the encoding system, the update to a decoding system.

11. The method of claim 8, wherein training the encoder-side neural networks comprises:
decoding, by the encoding system, the compressed training data item to generate a reconstructed training data item;
generating, by the encoding system, an input to the encoder-side neural network based upon the decoding;
processing, by the encoder-side neural network, the input to the encoder-side neural network to generate a network output; and
adjusting, by the encoding system, the parameters of the encoder-side neural network based upon the generated network output and a corresponding target output based upon the decoding.

12. The method of claim 11, wherein generating an input to the encoder-side neural network based upon the decoding comprises:
modifying, by the encoding system, the reconstructed training data item to reduce the quality of the reconstructed training data item; and
providing, by the encoding system, the reduced quality reconstructed training data item as the input to the encoder-side neural network; and
wherein the reconstructed training data item is the target output of the encoder-side neural network.

13. The method of claim 12, wherein modifying to reduce quality comprises modifying to introduce at least one of compression artifacts or distortions.

14. The method of claim 11, wherein generating an input to the encoder-side neural network is based upon an intermediate decoding output generated during decoding of the compressed data item.

15. The method of claim 9, wherein fine-tuning, by the encoding system, the encoder-side neural network comprises:
processing, by the encoder-side neural network, a fine-tuning input to the encoder-side neural network based upon decoding a compressed fine-tuning training data item to generate a first fine-tuning network output; and
adjusting, by the encoding system, the parameters of the encoder-side neural network based upon the fine-tuning network output and a corresponding fine-tuning target output.

16. The method of claim 15, wherein the fine-tuning input is the reconstructed training data item generated by decoding the compressed training data item and the fine-tuning target output is the training data item; or
the fine-tuning input is an intermediate decoding output generated during decoding of the compressed training data item.

17. The method of claim 15, wherein fine-tuning, by the encoding system, the encoder-side neural network comprises:
obtaining, by the encoding system, a second training data item;
encoding, by the encoding system, the second training data item to generate a second compressed training data item; and
decoding, by the encoding system, the second compressed training data item to generate a second reconstructed training data item.

18. The method of claim 17, wherein the fine-tuning input is the second reconstructed training data item, and the fine-tuning target output is the second training data item.

19. The method of claim 17, wherein the fine-tuning input is an intermediate decoding output generated during decoding of the second compressed training data item.

20. The method of claim 8, further comprising:
receiving, at the encoding system, a data item for encoding;
encoding, by the encoding system, the data item to generate a compressed data item;
decoding, by the encoding system, the compressed data item to generate a reconstructed data item;
fine-tuning, the encoder-side neural network, based upon the received data item and the reconstructed data item;
determining, by the encoding system, a second update to the decoder-side neural network based upon the parameters of the fine-tuned encoder-side neural network and the parameters of the encoder-side neural network prior to fine-tuning; and
transmitting, by the encoding system, the second update and the compressed data item to the decoding system.
